(19) United States
(12) Patent Application Publication
(10) Pub. No.: US 2005/0273571 A1
(43) Pub. Date: Dec. 8, 2005

(54) Distributed virtual multiprocessor

(76) Inventors: Thomas L. Lyon, Palo Alto, CA (US); Peter Newman, Mountain View, CA (US); Joseph R. Eykholt, Los Altos, CA (US)

Correspondence Address: Shemwell Gregory & Courtney LLP;Suite 201, 4880 Stevens Creek Boulevard, San Jose, CA, 95129, US

(21) Appl. No.: 10/948,064

(22) Filed: Sep. 23, 2004

Related U.S. Application Data
(60) Provisional application No. 60/576,558, filed on Jun. 2, 2004.
(60) Provisional application No. 60/576,885, filed on Jun. 2, 2004.

(51) Int. Cl. G06F 12/08

(52) U.S. Cl. 711/203

(57) ABSTRACT

A distributed virtual multiprocessor having a plurality of nodes coupled to one another by a network. A first node of the distributed virtual multiprocessor page faults in response to an instruction that indicates a memory reference at a virtual address. The first node indexes a first address translation data structure maintained therein to obtain an intermediate address that corresponds to the virtual address, then transmits the intermediate address to a second node of the distributed virtual multiprocessor to request a copy of a memory page that corresponds to the intermediate address. The first node receives a copy of the memory page that corresponds to the intermediate address from the second node, stores the copy of the memory page at a physical address, then loads a second address translation data structure with translation information that indicates a translation of the virtual address to the physical address. Thereafter, the first node resumes execution of the instruction that yielded the page fault, completes an instructed memory access by indexing the second address translation data structure with the virtual address to obtain the physical address, then accessing memory at the physical address.

### CROSS-REFERENCE TO RELATED APPLICATIONS

This application claims priority from and hereby incorporates by reference each of the following U.S. Provisional Patent Applications:

| Application No. | Filing Date | Title |
|---|---|---|
| 60/576,558 | Jun. 2, 2004 | Symmetric Multiprocessor Linux |
| | | Implemented on a Cluster |
| 60/576,885 | Jun. 2, 2004 | Netillion VM/DSM Architecture |

### FIELD OF THE INVENTION

The present invention relates to data processing, and more particularly to multiprocessor interconnection and virtualization in a clustered data processing environment.

### BACKGROUND

Multiprocessor computers achieve higher performance than single-processor computers by combining and coordinating multiple independent processors. The processors can be either tightly coupled in a shared-memory multiprocessor or the like, or loosely coupled in a cluster-based multiprocessor system.

Shared-memory multiprocessors (SMPs) typically offer a single shared memory address space and incorporate hardware-based support for synchronization and concurrency at cache-line granularity. SMPs are generally easy to maintain because they have a single operating system image and are relatively simple to program because of their shared memory programming model. However, SMPs tend to be expensive due to the specialized processors and coherency hardware required.

Cluster-based multiprocessors, by contrast, are typically implemented by multiple low-cost computers interconnected by a local area network and are thus relatively inexpensive to construct. A distributed shared-memory (DSM) software component allows application programs to coherently share memory between the computers of the cluster, allowing application programs to be implemented as if intended to execute on an SMP. FIG. 1, for example, illustrates a prior-art cluster-based multiprocessor 100 (cluster for short) formed by three low-cost computers 101₁-101₃ connected via a network 103. Each computer 101 is referred to herein as a node of the cluster and includes a hardware set (HW₁-HW₃) (e.g., processor, memory and associated circuitry to enable access to memory and peripheral devices such as network 103) and an operating system (OS₁-OS₃) implemented by execution of operating system code stored in the memory of the hardware set. A page-coherent distributed shared memory layer (DSM₁-DSM₃), also implemented by processor execution of stored code, is mounted on top of the operating system of each node 101 (i.e., loaded and executed under operating system control) to present a shared-memory interface to an application program 107. In a typical cluster implementation, the operating system of each node 101 allocates respective regions of the node's physical memory to application programs executed by the cluster and establishes a translation data structure, referred to herein as a hardware page table 105 (HWPT), to map the allocated physical memory to a range of virtual addresses referenced by the application program itself. Thus, when the processor of node 101₁, for example, encounters an instruction to read or write memory at a virtual address reference (i.e., as part of program execution), the processor applies the virtual address against the hardware page table (i.e., indexes the table using the virtual address) in a physical address look up operation shown at (1). If the page of memory containing the desired physical address (i.e., the requested page) is resident in the physical memory of node 101₁, then a virtual-to-physical address translation (VA/PA) will be present in the hardware page table 105 and the physical address is returned to the processor to enable the memory access to proceed. If the requested page is not resident in the physical memory of node 101₁, a fault handler in the operating system for node 101₁ is invoked at (2) to allocate the requested page and to populate the hardware page table 105 with the corresponding address translation.

In a single-processor system, a fault handler simply allocates a requested page by obtaining the physical address of a memory page from a list of available memory pages, filling the page with appropriate data (e.g., zeroing the page or loading contents of a file or swap space into the page), and populating the hardware page table with the virtual-to-physical address translation. In the cluster of FIG. 1, however, the desired memory page may be resident in the memory of another node 101 as, for example, when different processes or threads of an application program share a data structure. Thus, the fault handler of node 101₁ passes the virtual address that produced the page fault to the DSM layer at (3) to determine if the requested page is resident in another node of the cluster and, if so, to obtain a copy of the page. The DSM layer determines the location of a node containing a page directory for the virtual address which, in the example shown, is assumed to be node 101₂. Thus, at (4), the DSM layer of node 101₂ receives the virtual address from node 101₁ and applies the virtual address against a page directory 109 to determine whether a corresponding memory page has been allocated and, if so, the identity of the node on which the page resides. If a memory page has not been allocated, then node 101₂ notifies node 101₁ that the page does not yet exist so that the operating system of node 101₁ may allocate the page locally and populate the hardware page table 105 as in the single-processor example discussed above. If a memory page has been allocated, then at (5), the DSM layer of node 101₁ issues a page copy request to a node holding the page which, in this example, is assumed to be node 101₃. At (6), node 101₃ identifies the requested page (e.g., by invoking the operating system of node 101₃ to access the local hardware page table and thus identify the physical address of the page within local memory), then transmits a copy of the page to node 101₁. The DSM layer of node 101₁ receives the page copy at (7) and invokes the operating system at (8) to allocate a local physical page in which to store the page copy received from node 101₃, and to populate the hardware page table 105 with the corresponding virtual-to-physical address translation. After the hardware page table 105 has been updated with a virtual-to-physical address translation for the fault-producing virtual address, the fault handler of node 101₁ terminates, enabling node 101₁ to resume execution of the process that yielded the page fault, this time finding the necessary translation in the hardware page table 105 and completing the memory access.

Although relatively inexpensive to implement, cluster-based multiprocessors suffer from a number of disadvantages that have limited their application. First, clusters have traditionally proven hard to manage because each node typically includes an independent operating system that must be configured and managed, and which may have a different state at any given time from the operating system in other nodes of the cluster. Also, as clusters typically lack hardware support for concurrency and synchronization, such support must usually be provided explicitly in software application programs, increasing the complexity and therefore the cost of cluster programming.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a prior-art cluster-based multiprocessor;

FIG. 2 illustrates a distributed virtual multiprocessor according to an embodiment of the invention;

FIG. 3 illustrates an example of a memory access in the distributed virtual multiprocessor of FIG. 2;

FIG. 4 illustrates an exemplary mapping of the different types of addresses discussed in reference to FIGS. 2 and 3;

FIG. 5 illustrates an exemplary composition of a virtual address, apparent physical address, and physical address that may be used in the distributed virtual multiprocessor of FIG. 2;

FIG. 6 illustrates an exemplary page directory structure formed collectively by node-distributed page directories;

FIG. 7 illustrates an alternative embodiment of a page state element;

FIG. 8 illustrates an exemplary set of memory page transactions that may be carried out within the distributed virtual multiprocessor of FIG. 2;

FIG. 9 illustrates an embodiment of a distributed virtual multiprocessor capable of hosting multiple operating systems;

FIG. 10 illustrates an exemplary migration of tasks between virtual multiprocessors of a distributed virtual multiprocessor; and

FIG. 11 illustrates a node startup operation 700 within a distributed virtual multiprocessor according to one embodiment.

### DETAILED DESCRIPTION

In the following description, exemplary embodiments of the invention are set forth in specific detail to provide a thorough understanding of the invention. It will be apparent to one skilled in the art that such specific details may not be required to practice the invention. In other instances, known techniques and devices may be shown in block diagram form to avoid obscuring the invention unnecessarily. The term “exemplary” is used herein to express an example, not a preference or requirement.

In embodiments of the present invention, a memory sharing protocol is combined with hardware virtualization to enable multiple nodes in a clustered data processing environment to present a unified virtual machine interface. Through such interface, the entire cluster is virtualized, in effect, appearing as a unified, multiprocessor hardware set referred to herein as a distributed virtual multiprocessor (DVM). Accordingly, operating systems and application programs designed to be executed in a shared-memory multiprocessor (SMP) environment may instead be executed on the DVM, thereby achieving maintenance benefits of an SMP at the reduced cost of a cluster.

Overview of a Distributed Virtual Multiprocessor

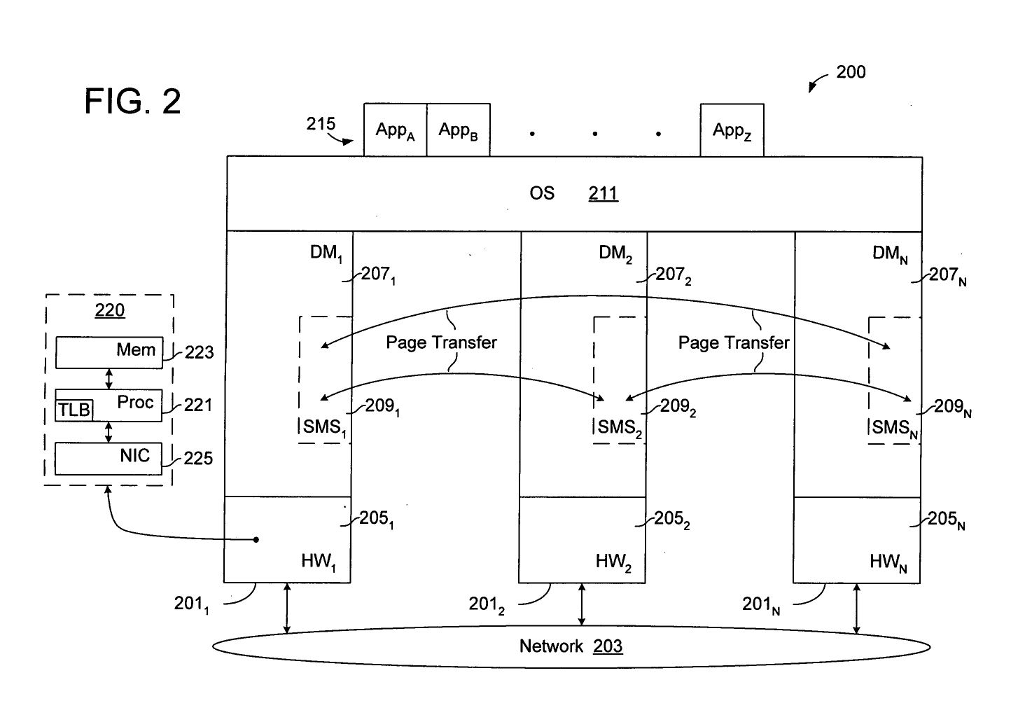

FIG. 2 illustrates a distributed virtual multiprocessor 200 according to an embodiment of the invention. The DVM 200 includes multiple nodes 201₁-201_{N} interconnected to one another by a network 203, each node including a hardware set 205₁-205_{N} (HW) and domain manager 207₁-207_{N} (DM). As shown at 220, the hardware set 205 of each node 201 includes a processing unit 221, memory 223, and network interface 225 coupled to one another via one or more signal paths. The processing unit 221 is generally referred to herein as a processor, but may include any number of processors, including processors of different types such as combinations of general-purpose and special-purpose processors (e.g., graphics processor, digital signal processor, etc.). Each processor of processing unit 221 or any one of them may include a translation lookaside buffer (TLB) to provide a cache of virtual-to-physical address translations. The memory 223 may include any combination of volatile and non-volatile storage media having memory-mapped and/or input-output (I/O) mapped addresses that define the physical address range of the hardware set and therefore the node. The network interface may be, for example, an interface adapter for an local area network (e.g., Ethernet), wide area network, or any other communications structure that may be used to transfer information between the nodes 201 of the DVM. Though not specifically shown, the hardware set of each node 201 may include any number of peripheral devices coupled to the processor 221 as well as or other elements of the hardware set via buses, point-to-point links or other interconnection media and chipsets or other control circuitry for managing data transfer via such interconnection media.

The domain manager 207 in each DVM node 201 is implemented by execution of domain manager code (i.e. programmed instructions) stored in the memory of the corresponding hardware set 205 and is used to present a virtual hardware set to an operating system 211. That is, the domain manager 207 emulates an actual or idealized hardware set by presenting an emulated processor interface and emulated physical address range to the operating system 211. The emulated processor is referred to herein as a virtual processor and the emulated physical address range is referred to herein as an apparent physical address (APA) range. The domain managers 207₁-207_{N} additionally include respective shared memory subsystems 209₁-209_{N} (SMS), that enable page-coherent sharing of memory pages between the DVM nodes, thus allowing a common APA range to extend across all the nodes of the DVM 200. By this arrangement, the domain managers 207₁-207_{N} of the DVM nodes present a collection of virtual processors to the operating system 211 together with an apparent physical address range that corresponds to the shared memory programming model of a shared-memory multiprocessor. Thus, the DVM 200 emulates a shared-memory multiprocessor hardware set by presenting a virtual machine interface with multiple processors and a shared memory programming model to the operating system 211. Accordingly, any operating system designed to execute on a shared-memory multiprocessor (e.g., Shared-memory multiprocessor Linux) may instead be executed by the DVM 200, with application programs hosted by the operating system (e.g., application programs 215) being assigned to the virtual processors of the DVM 200 for distributed, concurrent execution.

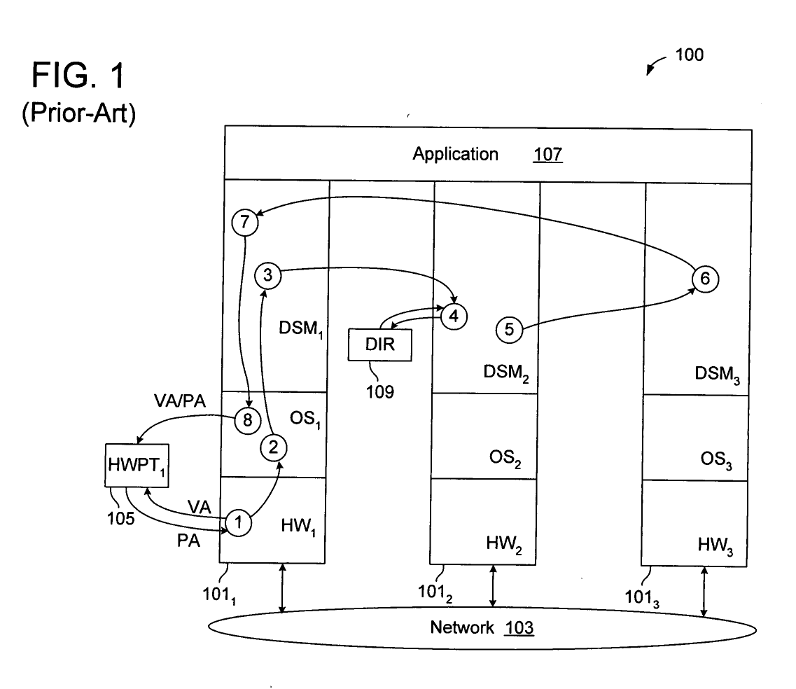

In contrast to the prior-art cluster-based multi-processing system of FIG. 1, the DVM 200 of FIG. 2 enables multiprocessing using a single operating system, thereby avoiding the multi-operating system maintenance usually associated with prior-art clusters. Also, because the shared memory subsystem 209 is implemented below the operating system, as part of the underlying virtual machine, page-coherency protocols need not be implemented in the application programming layer, thus simplifying the application programming task. Further, because the domain manager 207 virtualizes the underlying hardware set, the domain manager in each node may present any number of virtual processors and apparent physical address ranges to the operating system layer, thereby enabling multiple operating systems to be hosted by the DVM 200. That is, the nodes 201₁-201_{N} of the DVM 200 may present a separate virtual machine interface to each of multiple hosted operating systems, enabling each operating system to perceive itself as the sole owner of an underlying hardware platform. Multi-OS operation is discussed in further detail below.

Although the DVM 200 of FIG. 2 is depicted as including a predetermined number of nodes (N), the number of nodes may vary over time as additional nodes are assimilated into the DVM and member nodes are released from the DVM. Also, multiple DVMs may be implemented on a common network with the DVMs having distinct sets of member nodes (no shared nodes) or overlapping sets of member nodes (i.e., one or more nodes being shared by multiple DVMs).

Memory Access in a Distributed Virtual Multiprocessor

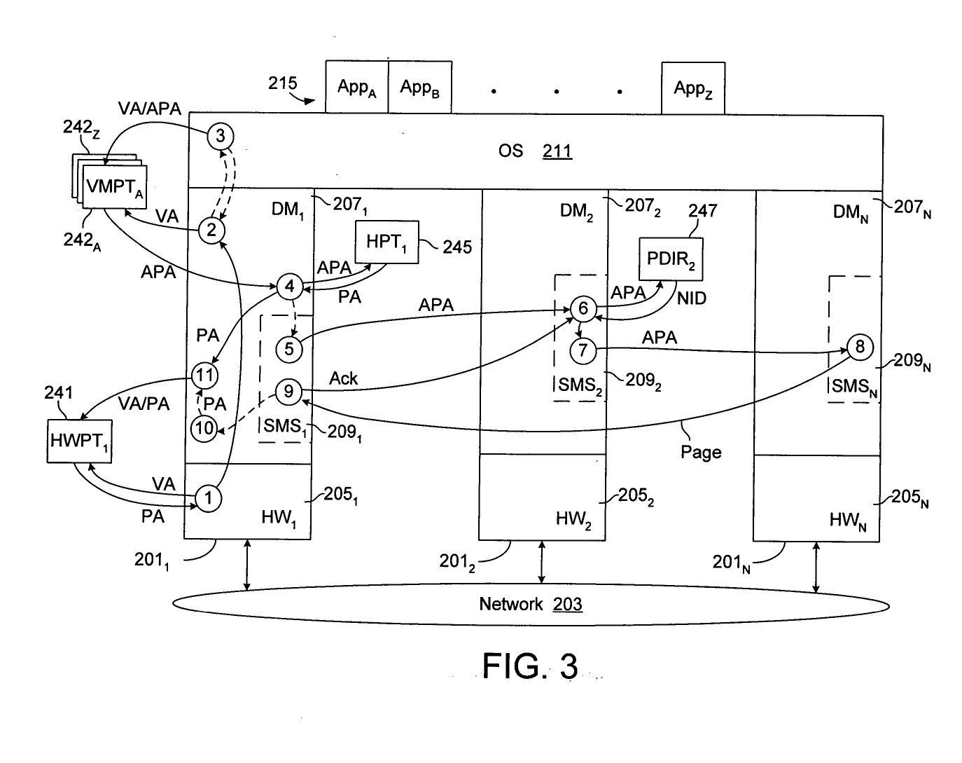

FIG. 3 illustrates an example of a memory access in the DVM 200 of FIG. 2. The memory access begins when the processing unit in one of the DVM nodes 201 encounters a memory access instruction (i.e., an instruction to read from or write to memory). Assuming that the memory access instruction is received in the processing unit of node 201₁, the processing unit initially applies a virtual address (VA), received in or computed from the memory access instruction, against a hardware page table 241 (HWPT₁), as shown at (1), to determine whether the hardware page table 241 contains a corresponding virtual-to-physical address translation (VA/PA). As discussed in reference to FIG. 2, the hardware set of node 201₂ or any of the nodes of the DVM 200 may include a translation-lookaside buffer (TLB) that serves as a VA/PA cache. In that case, the TLB may be searched before the hardware page table 241 and, if determined to contain the desired translation, may supply the desired physical address, obviating access to the hardware page table 241. If a TLB miss occurs (i.e., the desired VA/PA translation is not found in the TLB), the transaction proceeds with the hardware page table access shown at (1). If the VA-specified translation is present in the hardware page table 241, then a copy of the memory page that corresponds to the VA is present in the memory of node 201₁ (i.e., the local memory) and the physical address of the memory page is returned to the processing unit to enable the memory access to proceed. If the VA-specified translation is not present in the hardware page table 241, the processing unit of node 201₁ passes the virtual address to the domain manager 207₁ which, as shown at (2), applies the virtual address against a second address translation data structure referred to herein as a virtual machine page table 242_{A} (VMPT_{A}). The virtual machine page table constitutes a virtual hardware page table for the virtual processor implemented by the domain manager and hardware set of node 201₁ and thus enables translation of a virtual address into an apparent physical address (APA); an address in the unified address range of the virtual machine implemented collectively by the DVM 200. Accordingly, if a virtual address-to-apparent physical address translation (VA/APA) is stored in the virtual machine page table 242_{A}, the APA is returned to the domain manager 207₁ and used to locate the physical address of the desired memory page. If the VA/APA translation is not present in the virtual machine page table 242_{A}, the domain manager emulates a page fault, thereby invoking a fault handler in the operating system 211 (OS), as shown at (3). The OS fault handler allocates a memory page from a list of available pages in the APA range maintained by the operating system (a list referred to herein as a free list), then populates the virtual machine page table 242_{A} with a corresponding VA/APA translation. When the OS fault handler terminates, the dyomain manager 207₁ re-applies the virtual address to the virtual machine page table 242_{A} to obtain the corresponding APA, then passes the APA to the shared memory subsystem 209₁ as shown at (4) to determine the location of the corresponding physical page.

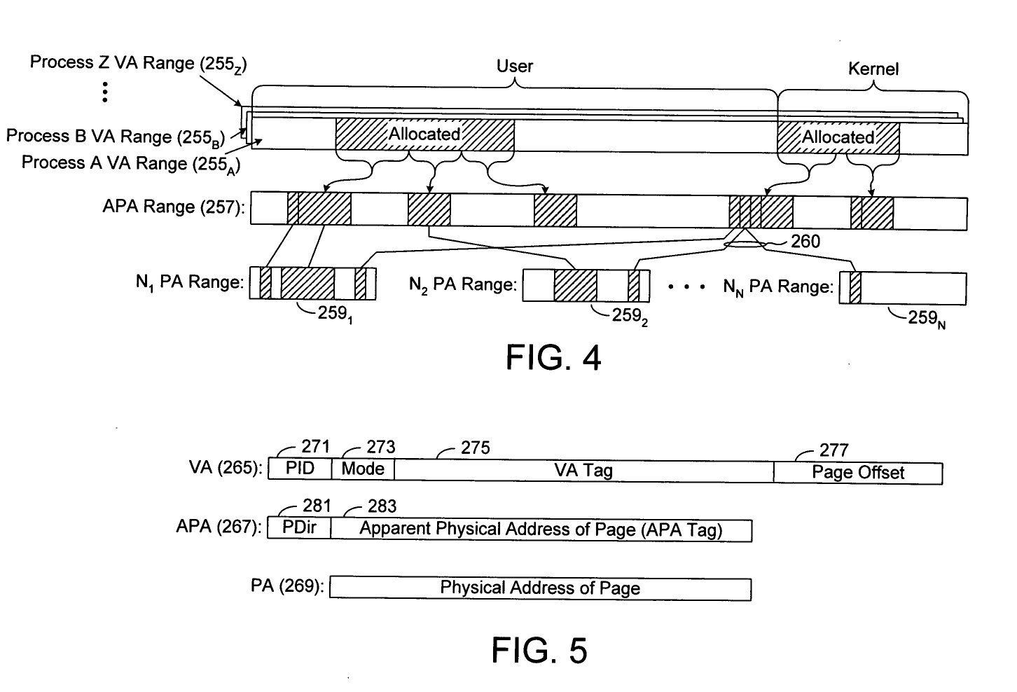

FIG. 4 illustrates an exemplary mapping of the different types of addresses discussed in reference to FIGS. 2 and 3, As mentioned above, a separate virtual address range 255_{A}, 255_{B}, . . . , 255_{Z} is allocated to each process executed in the DVM, with the operating system mapping the memory pages allocated in each virtual address range to unique addresses in an APA range 257. That is, because the operating system perceives the APA range 257 to represent the physical address space of an underlying machine, each virtual address in each process is mapped to a unique APA. Each APA is, in turn, mapped to a respective physical address in at least one of the DVM nodes (i.e., mapped to a physical address in one of physical address ranges 259₁-259_{N}) and, in the event that two or more nodes hold copies of the same page, an APA may be mapped to physical addresses in two different nodes as shown at 260. Such distributed page copies are referred to herein as shared-mode pages, in distinction to exclusive-mode pages which exist, at least for access purposes, in the physical address space of only one DVM node at a time.

In one embodiment, each virtual address range 255 is composed of at least two address sub-ranges referred to herein as a user sub-range and a kernel sub-range. The user sub-range is allocated to user-mode processes (e.g., application programs), while the kernel sub-range is allocated to operating system code and data. By this arrangement, operating system resources referenced (i.e., routines invoked, and data structures accessed) in response to process requests or actions may be referenced through the kernel sub-range of the virtual address space allocated to the process, and the kernel sub-range of the virtual address spaces for other processes may map to the same operating system resources where sharing of such resources is desired or necessary.

FIG. 5 illustrates an exemplary composition of a virtual address 265 (VA), apparent physical address 267 (APA), and physical address (PA) 269 that may be used in the DVM of FIG. 2. As shown, the virtual address 265 includes a process identifier field 271 (PID), mode field 273 (Mode), a virtual address tag field 275 (VA Tag), and a page offset field 277 (Page Offset). The process identifier field 271 identifies the process to which the virtual address 265 belongs and therefore may be used to distinguish between virtual addresses that are otherwise identical in lower order bits. In alternative embodiments, the process identifier field 271 may be excluded from the virtual address 265 and instead maintained as a separate data element associated with a given virtual address. The mode field 273 is used to distinguish between user and kernel sub-ranges within a given virtual address range, thus enabling the kernel sub-range to be allocate at the top of the virtual address space as shown in FIG. 4. The kernel sub-range may be allocated elsewhere in the virtual address space in alternative embodiments. The virtual address tag field 275 and page offset field uniquely identify a virtual memory page and offset within the page for a given process and sub-range. More specifically, the virtual address tag field 275 constitutes a virtual page address that maps to the apparent physical address of a particular memory page, and the page offset indicates an offset within the memory page of the memory location to be accessed. Thus, after the physical address of a memory page that corresponds to a virtual address tag field 276 has been obtained, the page offset field 277 of the virtual address 267 may be combined with the physical address to identify the precise memory location to be accessed.

In the embodiment of FIG. 5, the apparent physical address 267 includes a page directory field 281 (PDir) and an apparent physical address tag field 283 (APA Tag). The page directory field 281 is used to identify a node of the DVM that hosts a page directory for the apparent physical address 267, and the APA tag field 283 is used to resolve the physical address of the page on at least one of the DVM nodes. That is, the APA tag maps one-to-one to a particular physical page address 269. In alternative embodiments, the virtual address, apparent physical address and page address each may include additional and/or different address fields, with the address fields being arranged in any order within a given address value.

Returning to operation (4) of the memory access example in FIG. 3, when an APA is received within the shared memory subsystem 207₁, of node 201₁, the shared memory subsystem applies the APA against a searchable data structure (e.g., an array or list) referred to herein as a held-page table 245 (HPT) to determine if the requested memory page is present in local memory (i.e., the memory of node 201₁) and, if so, to obtain a physical address of the page from the held-page table 245. The memory page may be present in local memory despite absence of a translation entry in the hardware page table 241, for example, when the address translation for the memory page has been deleted from the hardware page table 241 due to non-access (e.g., translation deleted by a table maintenance routine that deletes translation entries in the hardware page table 241 according to a least recently accessed policy, or other maintenance policy).

If the held-page table 245 returns a physical address (i.e., the memory page is local), the physical address is loaded into the hardware page table 241 by the domain manager 207₁, as shown at (11), at a location indicated by the virtual address that originally produced the page fault (i.e., the hardware page table 241 is populated with a VA/PA translation). After loading the hardware page table, the fault handler in the domain manager 207₁, terminates, enabling process execution to resume in node 201₁, at the memory access instruction. As the virtual address indicated by the memory access instruction will now yield a physical address when applied to the hardware page table 241, the memory access may be completed and the instruction pointer of the processor advanced to the next instruction in the process.

If, in the operation at (4), the held-page table 245 indicates that the requested memory page is not present in local memory, then at (5) the shared memory subsystem 209₁, identifies a node of the DVM 200 assigned to manage access to the APA-indicated memory page, referred to herein as a directory node, and initiates inter-node communication to the directory node to request a copy of the memory page. In one embodiment, page management responsibility is distributed among the various nodes of the DVM 200 so that each node 201 is the directory node for a different range or group of APAs. In the exemplary APA definition illustrated in FIG. 5, for example, the page directory field of a given APA may be used to identify the directory node for the APA in question through predetermined assignment, table lookup, hashing, etc. As a specific example, the N nodes of the DVM may be assigned to be the directory nodes for pages in APA ranges 0 to X-1, X to 2X-1, . . . , (N-1)X to NX-1, respectively, where N times X is the total number of pages in the APA range. However initialized, directory node assignment may be changed through modification of a table lookup or hashing function, for example, as nodes are released from and/or added to the DVM 200. Also, page management responsibility may be centralized in a single node or subset of DVM nodes in alternative embodiments.

After the shared memory subsystem 209₁ identifies the directory node for the APA obtained at (2), the shared memory subsystem 209₁ issues a page copy request to a directory manager within the directory node, a component of the directory node's shared memory subsystem. If the node requesting the page copy (i.e., the requestor node) is also the directory node, a software component within the local shared memory subsystem, referred to herein as a directory manager, is invoked to handle the page copy request. If the directory node is remote from the requestor node, inter-node communication is initiated by the requestor node (i.e., via the network 203) to deliver the page copy request to the directory manager of the directory node. In the exemplary memory access of FIG. 3, node 201₂ is assumed to be the directory node so that, at (6) a broker within the shared memory subsystem 209₂ receives a page copy request from requestor node 201₁. In one embodiment, the page copy request conveys the APA of a requested memory page together with a page mode value that indicates whether a shared copy of the page is requested (e.g., as in a memory read operation) or exclusive access to the page is requested (e.g., as in a memory write operation). The page copy request may also indicate a node to which a response is to be directed (as discussed below, a directory node may forward a page copy request to a page holder, instructing the page holder to respond directly to the node that originated the page copy request). The broker of node 201₂ responds to the page copy request by applying the specified APA against a lookup data structure, referred to herein as a page directory 247, that indicates, for each allocated page in a given APA sub-range, which nodes 201 of the DVM 200 hold copies of the requested page, and whether the nodes hold the page copies in exclusive or shared mode. As discussed below, shared-mode pages may be accessed by any number of DVM nodes simultaneously (e.g., simultaneous read operations), while exclusive-mode pages (e.g., pages held for write access) may be accessed by only one node at a time.

Assuming that the page directory 247 accessed at (6) indicates that node 201_{N} holds a shared-mode copy of the page in question, then at (7), the directory manager of directory node 201₂ forwards the page copy request received from requestor node 201₁ to the shared memory subsystem 209_{N} of the page-holder node 201_{N}, instructing node 201_{N} to transmit a copy of the requested page to requestor node 201₁. As shown at (8), node 201_{N} responds to the page copy request from directory node 201₂ by transmitting a copy of the requested page to the requestor node 201₁.

Completing the memory access example of FIG. 3, the shared memory subsystem 201₁ of node 201₁ receives the page copy from node 201_{N} at (9), and issues an acknowledgment of receipt (Ack) to the broker of directory node 201₂. The broker of node 201₂ responds to the acknowledgment from requestor node 201₁ by updating the page directory to identify requestor node 201₁ as an additional page holder for the APA-specified page. At (10), the domain manager 207₁ of node 201₁ allocates a physical memory page into which the page copy received at (9) is stored, thus creating an instance of the memory page in the physical address space of node 201₁. The physical address of the page allocated at (10) is used to populate the hardware page table with a VA/PA translation at (11), thus completing the task of the fault handler within the domain manager 207₁, and enabling process execution to resume at (1). As the hardware page table is now populated with the necessary VA/PA translation, the memory access is completed and the instruction pointer of the processing unit advanced to the next instruction in the process.

Still referring to FIG. 3, it should be noted that the operations carried out by the domain managers 207 and shared memory subsystem 209 within the various DVM nodes will vary depending on the nature of the memory access instruction detected at (1). In the example described above, it is assumed that the page fault produced at (1) indicated need for a shared-mode copy of a memory page. Other memory access instructions, such as write instructions, may require exclusive-mode access to a memory page. In such cases, if a VA/PA translation is not present in the hardware page table 241, then the domain manager 207 and shared memory subsystem 209 are invoked to populate the hardware page table 241 generally in the manner described above. If the hardware page table 241 contains the necessary VA/PA translation, but indicates that the page is held in shared mode (i.e., shared mode), then the domain manager 207 is invoked to convert the page mode from shared to exclusive mode. In such an operation, the shared memory subsystem 209 is invoked to communicate a mode conversion request to the directory node for the memory page in question. The directory node, in response, instructs other page holders, if any, to invalidate their copies of the subject memory page, then, after receiving notifications from each of the other page holders that their pages have been invalidated, updates the page directory to show that the requester node holds the page in exclusive mode and informs the requestor node that the page mode conversion is complete. Thereafter, the requester node may proceed to write the page contents, for example, by overwriting existing data with new data or by performing any other content-modifying operation such as a block erase operation or read-modify-write operation.

Shared Memory Subsystem, Page Transfer and Invalidation Operations

Referring again to FIGS. 2 and 3, the shared memory subsystems 209₁-209_{N} enable memory pages to be shared between nodes of the DVM 200 by implementing a page-coherent memory sharing protocol that is described herein in terms of a page directory and various agents. Agents are implemented by execution of program code within the shared memory subsystems 209₁-209_{N} and interact with one another to carry out memory page transactions. In one embodiment, each shared memory subsystem 209 includes a single agent that may alternately act as a requester, directory manager, or responder in a given memory page transaction. In the case of a responder, the agent may act on behalf of a page owner node or a copy holder node as discussed in further detail below. In alternative embodiments, multiple agents may be provided within each shared memory subsystem 209, each dedicated to performing a requestor, directory manager or responder role, or each capable of acting as either a requester, directory manager and/or responder.

The page directory is a data structure that holds the current state of allocated memory pages though it does not hold the memory pages themselves. In one embodiment, a single page directory is provided for all allocated memory pages and hosted on a single node of the DVM 200. As mentioned above, in an alternative embodiment, multiple page directories that collectively form a complete page directory may be hosted on respective DVM nodes, each of the page directories having responsibility to maintain page status information for a respective subset of allocated memory pages. In one implementation, the page directory indicates, for each memory page in its charge, the mode in which the page is held, exclusive or shared, the node identifier (node ID) of a page owner and the node ID of copy holders, if any. Herein, page owner refers to a DVM node tasked with ensuring that its copy of a memory page is not invalidated (or deleted or otherwise lost) until receipt of confirmation that another node of the DVM has a copy of the page and has been designated the new page owner, or until an instruction to delete the memory page from the DVM is received. A copy holder is a DVM node, other than the page owner, that has a copy of the memory page. Thus, in one embodiment, each allocated memory page is held by a single page owner and by any number of copy holders or no copy holders at all. Each memory page may also be held in exclusive mode (page owner, no copy holders) or shared mode (page owner and any number of copy holders or no copy holders) as discussed above.

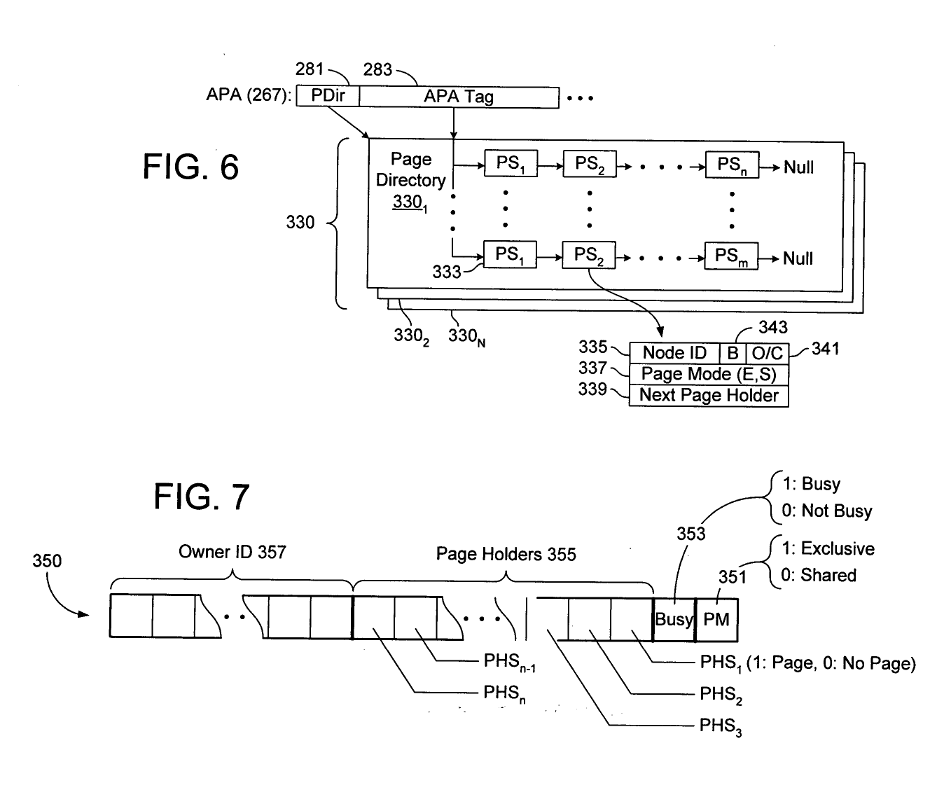

Generally speaking, a centralized or distributed page directory may be implemented by any data structure capable of identifying the page owner, copy holders (if any), and page mode (exclusive or shared) for each memory page in a given set of memory pages (i.e., all allocated memory pages, or a subset thereof). FIG. 6, for example, illustrates a page directory structure 330, formed collectively by node-distributed page directories 330₁-330_{N}. In one embodiment, discussed above in reference to FIG. 5, a page directory field 281 within an apparent physical address 267 (APA) is used to identify one of the page directories 330₁-330_{N} as being the directory containing the page owner, copy holder and page mode information for the memory page sought to be accessed. As discussed, the page directories may be distributed among the nodes of the DVM in various ways and may be directly selected or indirectly selected (e.g., through lookup or hashing) by the page directory field 281 of APA 267. In alternative embodiments, the page directory may be centralized, for example, in a single node of the DVM 200 so that all page copy and invalidation requests are issued to a single node. In such an embodiment, the page directory field 281 may be omitted from the APA 267 and, instead, a pointer maintained within the shared memory subsystem of each DVM node to identify the node containing the centralized page directory. A centralized page directory node may also be established by design, for example, as the DVM node least recently added to the system or the DVM node having the lowest or highest node identifier (NID).

Still referring to FIG. 6, each page directory 330₁-330_{N} stores page state information for a distinct range or group of APAs. In the particular embodiment shown, the page state information for each APA is maintained as a respective list of page state elements 333 (PS), with each page state element 333 including a node identifier 335 to identify a page-holding node, a page mode indicator 337 to indicate the mode in which the page is held (e.g., exclusive (E) or shared (S)), and a pointer 339 to the next page state element in the list, if any. The pointer of the final page state element in the list points to null or another end-of-list indicator. The tag field of the APA 267 (which may include any number of additional fields indicated by the ellipsis in FIG. 6) is used directly or indirectly (e.g., through hashing) to index a selected one of the page directories 330₁-330_{N} and thereby obtain access to the page state list for the corresponding memory page. By this arrangement, page state elements 333 may be added to and deleted from the list to reflect the addition and deletion of copies of the memory page in the various nodes of the DVM. Similarly, the page mode indicator 337 in each page holder element may be modified as necessary to reflect changed page modes for pages in the DVM nodes. Other data elements may be included within the page state elements 333 in alternative embodiments, such as an ownership indicator 341 (O/C) indicating whether a given page holder is page owner or a copy holder, a busy indicator 343 (B) to indicate whether a transaction is in progress for the memory page, or any other information that may be useful to describe the status of the memory page or transactions relating thereto. For example, as discussed below, each page state element may additionally include storage for a generation number that is incremented each time a new page owner is assigned for the memory page, and a request identifier (request ID) that enables requests directed to the memory page to be distinguished from one another.

In an alternative embodiment, each of the page directories 330₁-330_{N} of FIG. 6 may be implemented by an array of page state elements. Referring to FIG. 7, for example, each page state element may be a single data word 350 (e.g., having a number of bits equal to the native word width of a processor within one or more of the hardware sets of the DVM) having a page mode field 351 (PM), busy field 353 (B), page holder field 355 and owner ID field 357. The page mode field, which may be a single bit, indicates whether the memory page is held in exclusive mode or shared mode. The busy field, which may also be a single bit, indicates whether a transaction for the memory page is in progress. The page holder field is a bit vector in which each bit indicates the page holding status (PHS) of a respective node in the DVM. The owner ID field 357 holds the node ID of the page owner. In one embodiment, for example, the page state element 350 is a 64-bit value in which bit 0 constitutes the page mode field, bit 1 constitutes the busy field, bits 2-57 constitute the page holder field (thereby indicating which of up to 56 nodes of the DVM are page holders) and bits 58-63 constitute a 6-bit page owner field. Each page-holding status bit (PHS) within the page holder field 355 may be set (e.g., to a logic ‘1’) or reset according to whether the corresponding DVM node holds a copy of the memory page, and the page owner field 357 indicates which of the page holders is the page owner (all other page holders therefore being copy holders). In alternative embodiments, the fields of the page state element may be disposed in different order and may each have different numbers of constituent bits. Also, more or fewer fields may be provided in each page state element 350 (e.g., a generation number field and request ID field) and the page state element itself may have more or fewer constituent bits. Further, instead of being a single data word, the page state element 350 may be a structure or record having separate constituent data elements to hold the information in the owner ID field, page mode field, busy field, page holder fields and/or any other fields.

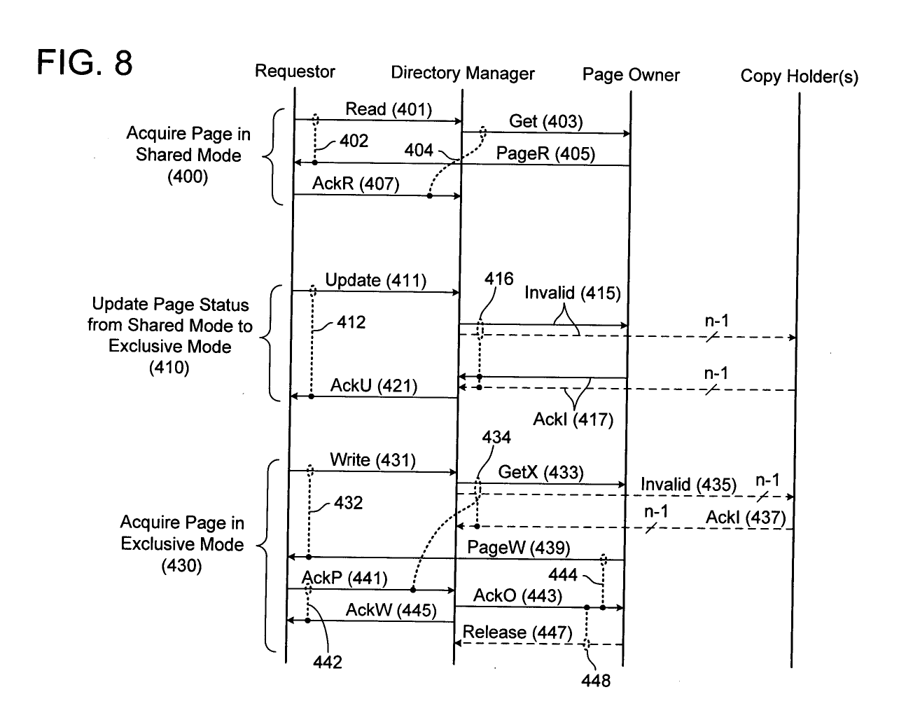

FIG. 8 illustrates an exemplary set of memory page transactions that may be carried out within the DVM 200 of FIG. 2, including a shared-mode memory page acquisition 400, a page mode update transaction 410 (i.e., updating the mode in which a page is held from shared mode to exclusive mode), and an exclusive-mode memory page acquisition 430. For purposes of example, a single-writer, sequential-transaction protocol is assumed. In a single-writer protocol, either many nodes may have a copy of the same page for reading or a single node may have the page for writing. Other coherency protocols may be used in alternative embodiments. In a sequential transaction protocol, only one transaction directed to a given memory page is in progress at a given time. In alternative embodiments, multiple transactions may be carried out concurrently (i.e., at least partly overlapping in time) as, for example, where multiple shared-mode acquisitions are handled concurrently. Also, in the exemplary protocol shown, all requests for copies of a page are directed to the page owner. In alternative embodiments, page requests may be issued to copy holders instead of the page owner, particularly where multiple shared-mode acquisitions of the same page are transacted concurrently.

In the protocol of FIG. 8, transactions 400, 410 and 430 are carried out through issuance of messages between a requester, directory manager, page owner and, if necessary, copy holders. The protocol does not distinguish communication between different nodes from communication between an agent and a directory manager on the same node (i.e., as when the requestor or responder is hosted on the same DVM node as the directory manager). In practice different communication mechanisms may be employed in these two cases. To cope with potential message loss, message-issuing agents may set timers to ensure that any anticipated response is received within a predetermined time interval. In FIG. 8, timers are depicted by a small dashed circle and connected line. The dashed circle indicates the message for which the timer is set and the dashed line connects with the message that, when received, will cancel (or delete, reset or otherwise shut off) the timer. If the anticipated response is received before the timer expires, the timer is canceled. If the timer expires before the response is received, one of a number of remedial actions may be taken including, without limitation, retransmitting the message for which the timer was set or transmitting a different message.

Each of the transactions 400, 410, 430 is initiated when a requestor submits a request message containing the APA of a memory page to a directory manager. The directory manager responds by accessing the page directory using the APA to determine whether the memory page is busy (i.e., a transaction directed to the memory page is already in progress) and, if so, issuing a retry message to the requestor, instructing the requestor to retry the request at a later time (alternatively, the directory manager may queue requests). If the memory page is not busy, the directory manager identifies the page owner and, if necessary for the transaction, the copy holders for the subject memory page and proceeds with the transaction.

In the embodiment of FIG. 8, the requester issues three types of requests to the directory manager: Read 401, Update 411 and Write 431, and it is assumed that the page directory holds at least the following state information for the subject memory page:
Busy: Indicates that a transaction is currently in progress on the page.
PM: Indicates whether the page is held in shared mode or exclusive mode.
Page Owner: Identifies the node that serves as the page owner.
Copy Holders: Identifies the nodes, other than the page owner, which hold copies of the page.
Generation Number: Incremented every time the page owner changes to protect against stale or duplicate messages.
Request ID: Indicates the request ID of the request the directory manager is busy serving, if any. It is also used to protect against stale or duplicate messages.
   Shared-Mode Page Acquisition

A requestor initiates the shared-mode page acquisition 400 by issuing a read message 401 to the directory manager, the Read message 401 including an APA of the desired memory page. The requestor also sets a timer 402 to guard against message loss. On receiving the Read message 401, the directory manager indexes the page directory using the APA to determine the status of the memory page and to identify the page owner. If the memory page is busy (i.e., another transaction directed to the memory page is in progress), the directory manager responds to the Read message 401 by issuing an Rnack message (not shown) to the requestor, thereby signaling the requester to resend the Read message 401 at a later time. In an alternative embodiment, the directory manager may simply ignore the Read message 401 when the page is busy, enabling timer 402 to expire and thereby signal the requestor to resend the Read message 401. If the memory page is not busy, the directory manager sets the busy flag in the appropriate directory entry, logs the request ID, forwards the request to the page owner in a Get message 403, and sets a timer 404. The page owner responds to the Get message 403 by sending a copy of the page to the requestor in a PageR message 405. On receipt of the PageR message 405, the requestor sends an AckR message 407 to the directory manager and cancels timer 402 On receipt of the AckR message 407, the directory manager updates the page directory entry for the subject memory page to indicate the new copy holder, resets the busy flag, and cancels timer 404.

Page Mode Update

The page mode update transaction 410 is initiated by a requestor node to acquire exclusive mode access to a memory page already held in shared mode. The requestor initiates a page mode update transaction by sending an Update message 411 to the directory manager for an APA-specified memory page and setting a timer 412. On receiving the Update message 411, the directory manager indexes the page directory using the APA to determine the status of the memory page and to identify the page owner and copy holders, if any. If the page is busy, the directory manager responds with a Unack message (not shown), signaling the requester to retry the update message at a later time. If the page is not busy, the directory manager sets the busy flag, makes a note of the request ID, sends an Invalid message 415 to the page owner and each copy holder, if any (i.e., the directory manager sends n Invalid messages 415, one to the page owner and n-1 to the copy holders, where n>1) and sets a timer 416. On receiving the Invalid message 415, the page owner invalidates its copy of the page and responds with an AckI message 417, acknowledging the Invalid message). Copy holders, if any, similarly respond to Invalid messages 415 by invalidating their copies of the memory page and responding to the directory manager with respective AckI messages 417. When AckI messages have been received from the page owner and all copy holders, the directory manager increments the generation number for the memory page to indicate the transfer of page ownership, sends an AckU message 421 to the requester, resets the busy flag, and cancels timer 416. On receipt of the AckU message 421, the requestor cancels timer 412. At this point, the requestor is the new page owner and holds the memory page in exclusive mode.

Exclusive-Mode Page Acquisition A requestor initiates an exclusive-mode page acquisition 430 by sending a Write message 431 to the directory manager and setting a timer 432. On receiving the write message 431, the directory manager indexes the page directory to determine the status of the APA-specified memory page and to identify the page owner and any copy holders. If the memory page is busy, the directory manager responds to the requestor with a Wnack message (not shown), signaling the requestor to retry the write message at a later time. If the memory page is not busy, the directory manager sets the busy flag for the memory page, records the request ID, sends a GetX message 433 to the page owner, and sets a timer 434. The directory manager also sends Invalid messages 435 to any copy holders. On receiving the GetX message 433, the page owner, sends a copy of the memory page to the requestor in a PageW message 439, invalidates its copy of the memory page, and sets a timer 444. On receiving an Invalid message, each copy holder invalidates its copy of the memory page and responds to the directory manager with an AckI message 437. On receipt of the PageW message 439, the requestor sends an AckP message 441 to the directory manager, and sets timer 442.

On receipt of the AckP message 441, the directory manager checks to see whether all the AckI messages 437 have been received from all copy holders (i.e., one AckI message 437 for each Invalid message 435, if any). When the AckP message 441 and all expected AckI messages have been received, the directory manager increments the generation number for the memory page, updates the state of the page to indicate the new page owner, resets the busy flag, sends an AckW message 445 to the requestor, sends an AckO message 443 to the previous page owner, and cancels timer 434. On receipt of the AckW message 445, the requestor cancels timer 442. On receipt of the AckO message 443, the previous page owner cancels timer 444.

In one embodiment, if timer 432 expires before the requestor receives the PageW message 439, the requester retransmits the Write message 431. If timer 442 expires before receipt of the AckW message 445, the requestor retransmits the AckP message 441. The directory manager retransmits a GetX message 433 if timer 434 expires, and the previous page owner transmits a Release message 447 and sets timer 448 if timer 444 expires before receipt of an AckO message 443. The previous page owner transmits a Release message 447 instead of retransmitting a PageW message 439 because the previous page owner is waiting for confirmation that it is released from ownership responsibility, and a Release message may be much smaller than a PageW message 439 (i.e., the Release message need not include the page copy). The timer 434 set by the directory manager protects against loss of a PageW message. In an alternative embodiment, the previous page owner may retransmit the PageW message 439 upon expiration of timer 444, instead of the Release message 447.

Message Duplication

As discussed in reference to FIG. 8, recovery from message loss is achieved through message retransmission when a corresponding timeout interval elapses. Message retransmission, however, may result in message duplication. More specifically, a duplicate message may arrive at a given agent (requestor, directory manager, page owner or copy holder) during the current transaction for a given memory page, or a duplicate message may arrive at a requestor after the transaction is completed and during execution of a subsequent transaction. In the embodiment of FIG. 8, protection against duplicate messages is achieved by including the request ID and generation number in each message for a given transaction. The request ID is incremented by the requestor on each new transaction. In one embodiment, each request ID is unique from other request IDs regardless of the node issuing the request (e.g., by including the node ID of the requestor as part of the request ID) and the width of the request ID field is large enough to protect against the longest time period a message can be delayed in the system. The request ID may be stored by the directory manager on accepting a new transaction, for example, in a field within the page directory entry for the subject memory page, or elsewhere within the node that hosts the directory manager. The requestor and directory manager may both use the request ID to reject duplicate messages from previous transactions.

The generation number for each memory page is maintained by the directory manager, for example, as a field within the page directory entry for the subject memory page. The generation number is incremented by the directory manager when exclusive ownership of the memory page changes. In one embodiment, for example, the generation number is incremented in an update transaction when all AckI messages are received. In an exclusive-mode page acquisition, the generation number is incremented when both the AckP and all AckI messages are received. The current generation number is set in Get, GetX, and Invalid messages and may additionally be carried in all response messages. The generation number is omitted from read and write request messages because the requestor does not have a copy of the memory page. By contrast, a generation number may be included in the Update message because the requestor in an update transaction already holds a copy of the memory page. The requestor in a page acquisition transaction may be given the generation number for a page when it receives an AckW message and/or upon receipt of the memory page itself (i.e., in PageR or PageW messages). The generation number allows the directory manager and the requestor to guard against duplicate messages that specify previous generations of the page.

Reflecting on the exemplary transaction protocols described in reference to FIG. 8, it should be noted that numerous other transaction protocols and/or enhancements to the transactions shown may be used to acquire memory pages and update page-holding modes in alternative embodiments. Also, other techniques may be employed to detect and remedy message loss and to protect against message duplication. In general, any protocol or technique for transferring memory pages among the nodes of the DVM and updating modes in which such memory pages are held may be used in alternative embodiments without departing from the spirit and scope of the present invention.

Distributed Virtual Multiprocessor with Multiple OS Hosting

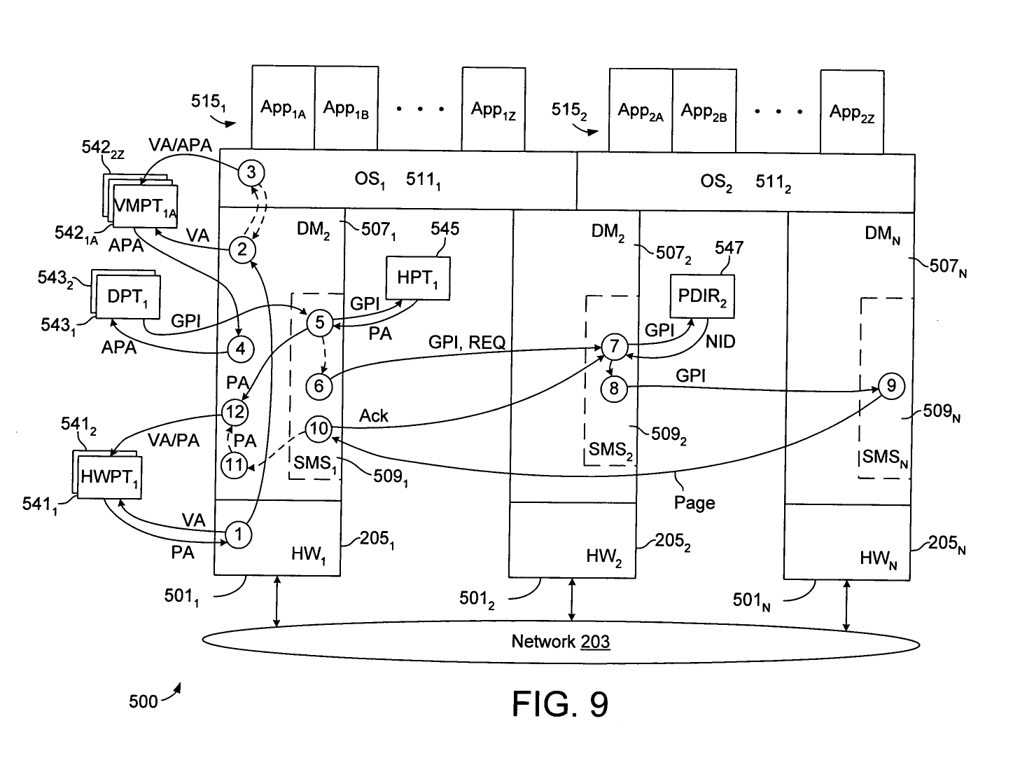

FIG. 9 illustrates an embodiment of a DVM 500 capable of hosting multiple operating systems, including multiple instances of the same operating system and/or different operating systems. The DVM 500 includes multiple nodes 501₁-501_{N} interconnected by a network 203, each node including a hardware set 205 (HW) and domain manager 507 (DM). The hardware set 205 and domain manager of each node 201 operate in generally the same manner as the hardware set and domain manager described in reference to FIGS. 2 and 3, except that each domain manager 507 is capable of emulating a separate hardware set for each hosted operating system, and maintains an additional address translation data structure 543, referred to herein as a domain page table, to enable translation of an apparent physical address (APA) into an address referred to herein as a global page identifier (GPI). The additional translation from APA to GPI enables allocation of multiple, distinct APA ranges to respective operating systems mounted on the DVM 500. In the particular example shown in FIG. 9, for example, a first APA range is allocated to operating system 511₁ (OS₁) and a second APA range is allocated to operating system 511₂ (OS₂), with any number of additional APA ranges being allocated to additional operating systems. Because each of the operating systems 511₁ and 511₂ perceives itself to be the owner of a dedicated hardware set (i.e., the DVM presents a distinct virtual machine interface to each operating system 511) and physical address range (i.e., an apparent physical address range), multiple instances of SMP-compatible operating systems (e.g., SMP Linux) may coexist on the DVM 500 and may load and control execution of respective sets of application programs (e.g., application programs 515₁ (App_{1A}-App_{1Z}) being mounted on operating system 511₁ and application programs 515₂ (APP_{2A}-App_{2Z}) being mounted on operating system 511₂) without requiring application-level or OS-level synchronization or concurrency mechanisms.

As in the DVM 200 of FIGS. 2 and 3, a memory access begins in the DVM 500 when the processing unit in one of the DVM nodes 501 encounters a memory access instruction. The initial operations of applying a virtual address (i.e., an address received in or computed from the memory access instruction) against a hardware page table 541 as shown at (1), faulting to the domain manager 507 in the event of a hardware page table miss to apply the virtual address against a virtual machine table 542, and faulting to the operating system in the event of a virtual machine page table miss to populate the virtual machine page table with the desired VA/APA translation are performed in generally the manner described above in reference to FIG. 3. Note that separate hardware page tables 541₁, 541₂ are provided for each virtual machine interface presented by the domain manager to enable each operating system 511₁, 511₂ to perceive a separate physical address range. Similarly, separate sets of virtual machine page tables 542_{1A}-542_{1Z} and 542_{2A}-542_{2Z} are provided for each APA range, with the set of tables accessed at (1), (2) and (3) being determined by the active operating system, i.e., the operating system on which the application program that yielded the page fault at (1) is mounted. Thus, if a memory access instruction in one of application programs 515₁ (App_{1A}-App_{1Z}) yielded the page fault, a corresponding one of virtual machine page tables VMPT_{1A}-VMPT_{1Z} is accessed at (2) (and, if necessary, loaded at (3)) to obtain an APA. If an instruction from one of applications 515₂ (App_{2A}-App_{2Z}) yielded the page fault, a corresponding one of virtual machine page tables VMPT_{2A}-VMPT_{2Z} is used to obtain the APA.

After an APA is obtained from a virtual machine page table 542 at (2), the APA is applied against a domain page table 543 for the active operating system at (4) to obtain a corresponding GPI. As shown, separate domain page tables 5431, 5432 are provided for each hosted operating system 511₁, 511₂ to allow different APA ranges to be mapped to the GPI range. In one embodiment, the GPI contains a page directory field and an apparent physical address tag as described in reference to the apparent physical address 267 of FIG. 5. Thus, the GPI is applied in operations at (5)-(11) in generally the same manner as the APA described in reference to FIG. 3 (i.e., the operations at (4)-(10) of FIG. 3) to obtain the physical address of a memory page, retrieving the page copy from a remote node via the shared memory subsystem if necessary. At (12), the VA/PA translation for the GPI-specified memory page is loaded into the hardware page table 541 for the active operating system and the fault handling procedure of the domain manager is terminated to enable the address translation operation at (1) to be retried against the hardware page table.

Task Migration

In one embodiment, a multiprocessor-compatible operating system executing on the DVM of FIGS. 2 or 9 maintains a separate data structure, referred to herein as a task queue, for each virtual processor instantiated by the DVM. Each task queue contains a list of tasks (e.g., processes or threads) that the virtual processor is assigned to execute. The tasks may be executed one after another in round-robin fashion or in any other order established by the host operating system. When a virtual processor has completed executing application-level tasks, the virtual processor executes an idle task, an activity referred to herein as “idling,” until another task is assigned by the OS. Thus, the amount of processing assigned to a given virtual processor varies in time as the virtual processor finishes tasks and receives new task assignments. For this reason, and because execution times may vary from task to task, it becomes possible for one virtual processor to complete all its application-level tasks and begin idling while one or more others of the virtual processors continue to execute multiple tasks. When such a condition occurs, the operating system may re-assign one or more tasks from a loaded virtual processor to the idling virtual processor in a load-balancing operation.

In a multiprocessing system having a unified memory, the code and data (including stack and register state) for a given task may be equally available to all processors, so that any multiprocessor may simply access the task's code and data upon task reassignment and begin executing the task out of the unified memory. By contrast, in the DVMs of FIGS. 2 and 9, memory pages containing the code and data for a reassigned task are likely to be present on another node of the DVM (i.e., the node that was previously assigned to execute the task) so that, as a virtual processor begins referencing memory in connection with a re-assigned task, the memory access operations shown in FIGS. 3 and 9 are carried out to transfer the task-related memory pages from one node of the DVM to another. The re-assignment of tasks between virtual processors of a DVM and the transfer of corresponding memory pages are referred to collectively herein as task migration.

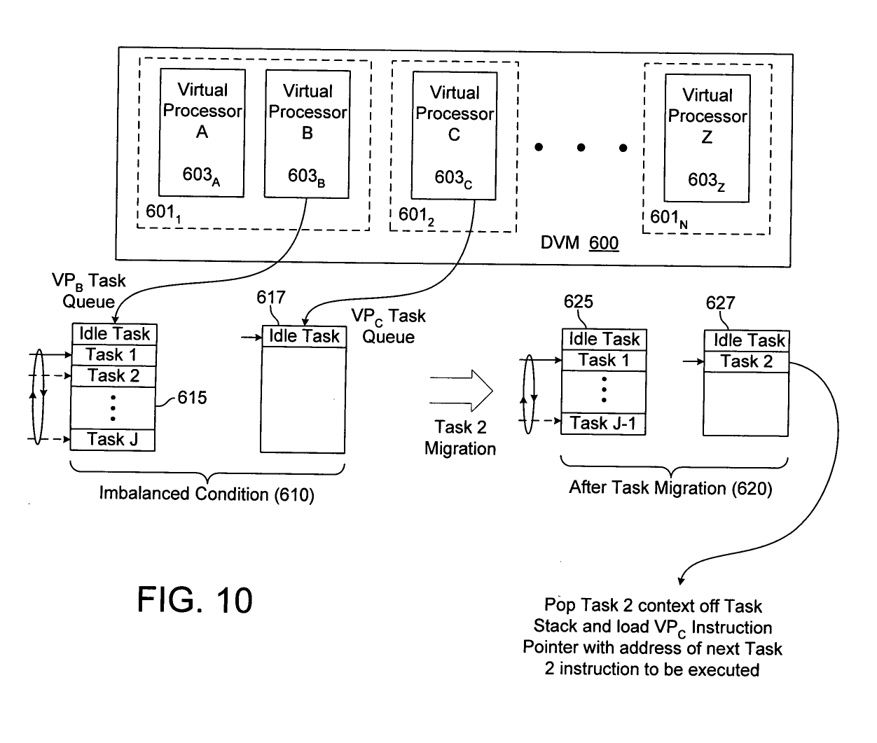

FIG. 10 illustrates an exemplary migration of tasks between virtual multiprocessors of a DVM 600. The DVM 600 includes N nodes, 601₁-601_{N}, each presenting one or more virtual processors to a multiprocessor-compatible operating system (not shown). In an initial imbalanced condition, shown at 610, virtual processor 603_{B} of node 600₁ is assumed to execute tasks 1-J, while virtual processor 603_{C} of node 601₂ idles. To correct this imbalance, illustrated by the state of the virtual processor task queues shown at 615 and 617, the operating system reassigns task 2 from virtual processor 603_{B} to virtual processor 603_{C}, as shown at 620. More specifically, when virtual processor 603_{B} is switched away from execution of task 2 to execute one of the other J tasks, the context of task 2 (e.g., the register state for the task including the instruction pointer, stack pointer, etc.) is pushed onto a task stack data structure maintained by the operating system, then the operating system copies the task identifier (task ID) of task 2 into the task queue for virtual processor 603_{C} and deletes the task ID from the task queue for virtual processor 603_{B}. The resulting state of the task queues for virtual processors 603_{B} and 603_{C} is shown at 625 and 627. When virtual processor 603_{C} examines its task queue and discovers the newly assigned task, virtual processor 603_{C} retrieves the context information from the task data structure, loading the instruction pointer, stack pointer and other register state information into the corresponding virtual processor registers. After the register state for task 2 has been recovered in virtual processor 603_{C}, virtual processor 603_{C} begins referencing memory to run the task (memory reference actually begins as soon as virtual processor B references the task data structure). The memory references eventually include the instruction indicated by the restored instruction pointer, which is a virtual address. For each such virtual address reference, the memory access operations described above in reference to FIGS. 3 and 9 are carried out. As all or most of the memory pages for task 2 are initially present in the physical memory of node 601₁, the shared memory subsystems of the DVM 600 will begin transferring such pages to the memory of node 601₂. As the balance of pages needed for task 2 execution shifts toward node 601₂, the amount of page transfer activity carried out by the shared memory subsystems will diminish.

It should be noted that, when virtual processor 603_{C} is assigned to execute and/or begins to execute task 2, multiple pages required for task execution may be identified and prefetched by the shared memory subsystem of node 601₂. For example, the pages of the task data structure (e.g., kernel-mapped pages) containing the task context information, one or more pages indicated by the saved instruction pointer and/or other pages may be prefetched.

Node Startup

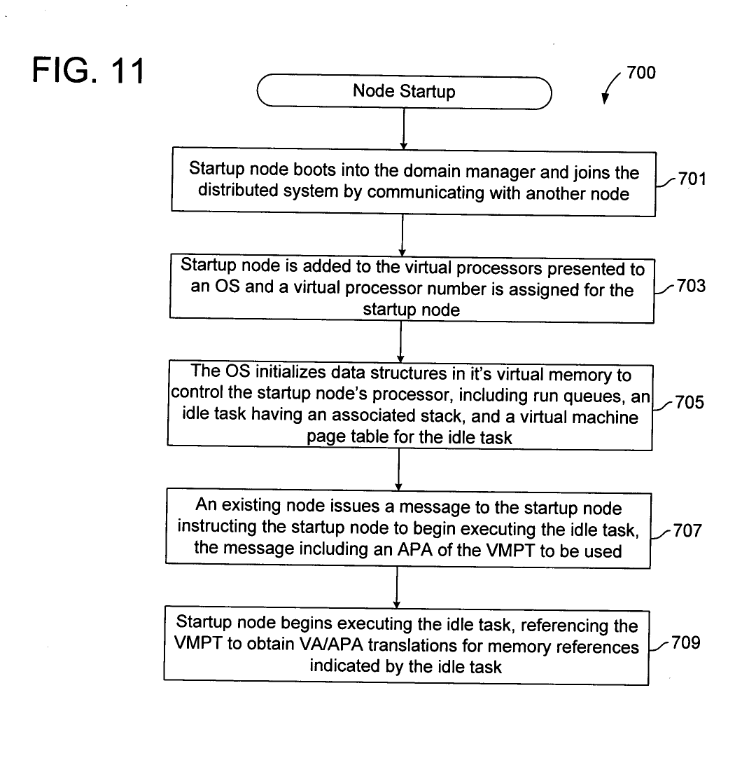

FIG. 11 illustrates a node startup operation 700 within a DVM according to one embodiment. Initially, at 701, a startup node (e.g., a node being powered up, or restarting in response to a hard or soft reset) boots into the domain manager and communicates its existence to another node of the DVM. The other node of the DVM notifies the operating system (or operating systems) that a new virtual processor is available and, at 703, a virtual processor number is assigned to the startup node and the startup node is added to a list of virtual processors presented to the operating system. At 705, the operating system initializes data structures in its virtual memory including one or more run queues for the virtual processor, and an idle task having an associated stack and virtual machine page table. Such data structures may be mapped, for example, to the kernel sub-range of the virtual address space allocated to the idle task. At 707, an existing node of the DVM issues a message to the startup node instructing the startup node to begin executing tasks on its run queue. The message includes an apparent physical address of the virtual machine page table allocated at 705. At 709, the startup node begins executing the idle task, referencing the virtual machine page table at the apparent physical address provided in 707 to resolve the memory references indicated by the task.

It should be noted that the domain manager, including the shared memory subsystem, and all other software components described herein may be developed using computer aided design tools and delivered as data and/or instructions embodied in various computer-readable media. Formats of files and other objects in which such software components may be implemented include, but are not limited to formats supporting procedural, object-oriented or other computer programming languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

When received within a computer system via one or more computer-readable media, such data and/or instruction-based expressions of the above described software components may be processed by a processing entity (e.g., one or more processors) within the computer system to realize the above described embodiments of the invention.

The section headings provided in this detailed description are for convenience of reference only, and in no way define, limit, construe or describe the scope or extent of such sections. Also, while the invention has been described with reference to specific embodiments thereof, it will be evident that various modifications and changes may be made thereto without departing from the broader spirit and scope of the invention. The specification and drawings are, accordingly, to be regarded in an illustrative rather than restrictive sense.

1. A method of operation in a data processing system, the method comprising:
detecting an instruction that indicates a memory reference at a first virtual address;
indexing at least a first address translation data structure to obtain an intermediate address that corresponds to the first virtual address;
transmitting the intermediate address to a node of the data processing system via a network interface to request a copy of a first data object that corresponds to the intermediate address;
receiving a copy of the first data object that corresponds to the intermediate address via the network interface;
storing the copy of the first data object in memory at a first physical address; and
loading a second address translation data structure with translation information that indicates a translation of the first virtual address to the first physical address.

2. The method of claim 1 further comprising indexing the second address translation data structure using the first virtual address to obtain the first physical address indicated by the translation information.

3. The method of claim 2 further comprising executing the instruction that indicates a memory reference.

4. The method of claim 3 wherein executing the instruction that indicates a memory reference comprises accessing memory at a location indicated by the first physical address.

5. The method of claim 1 further comprising:
indexing the second address translation data structure using the first virtual address; and
determining whether a translation from the first virtual address to the first physical address is present in the second address translation data structure, and wherein said indexing the first address translation data structure to obtain the intermediate address is performed in response to determining that the translation from the first virtual address to first physical address is not present in the second address translation data structure.

6. The method of claim 1 wherein transmitting the intermediate address to a node of the data processing system via a network interface comprises identifying a directory node responsible for maintaining status information for the first data object.

7. The method of claim 6 wherein identifying the directory node comprises identifying the directory node based on a field of bits within the intermediate address.

8. The method of claim 7 wherein identifying the directory node based on a field of bits within the intermediate address comprises indexing a lookup data structure using the field of bits.

9. The method of claim 7 wherein identifying the directory node based on a field of bits within the intermediate address comprises identifying the directory node directly from the field of bits.

10. The method of claim 1 further comprising indexing a held-page data structure using the intermediate address to determine if the first data object is stored in a local memory.

11. The method of claim 10 wherein said transmitting the intermediate address via a network interface and said receiving a copy of the first data object via the network interface are performed only if the first data object is determined not to be stored in the local memory.

12. The method of claim 1 1 wherein, if the first data object is determined not to be stored in the local memory, loading a second address translation data structure with translation information that indicates a translation of the first virtual address to the first physical address comprises determining a location in the local memory at which the first data object may be stored, the location in the local memory constituting the first physical address.

13. The method of claim 1 wherein the first data object is a memory page that spans a plurality of individually accessible storage locations.

14. The method of claim 1 wherein the first address translation data structure is an emulated hardware page table.

15. The method of claim 1 wherein indexing at least the first address translation data structure to obtain the intermediate address comprises:
indexing the first address translation data structure to obtain an apparent physical address; and
indexing a third address translation data structure using the apparent physical address to obtain the intermediate address.

16. The method of claim 15 further comprising:
allocating a plurality of ranges of apparent physical addresses within the data processing system; and
loading the third address translation data structure with information for translating an apparent physical address within any of the plurality of ranges to a respective intermediate address that corresponds to a unique data object.

17. A data processing system comprising:
a communications network;
a plurality of hardware sets each coupled to the communications network and including a processing unit and memory, the memory having first and second address translation data structures stored therein together with instructions which, when executed by the processing unit, causes said processing unit to:
receive a virtual address;
index the first address translation data structure to obtain an intermediate address that corresponds to the first virtual address;
transmit the intermediate address to another of the plurality of hardware sets via the communications network to request a copy of a first data object that corresponds to the intermediate address;
receive a copy of the first data object that corresponds to the intermediate address via the communications network;
store the copy of the first data object in the memory at a first physical address; and
load the second address translation data structure with translation information that indicates a translation of the first virtual address to the first physical address.

18. The data processing system of claim 17 wherein the instructions further cause the processing unit to index the second address translation data structure using the first virtual address to obtain the first physical address indicated by the translation information.

19. The data processing system of claim 17 wherein the instructions further cause the processing unit to:
index the second address translation data structure using the first virtual address; and
determine whether a translation from the first virtual address to the first physical address is present in the second address translation data structure, and wherein instructions that cause the processing unit to index the first address translation data structure to obtain the intermediate address are not executed if the translation from the first virtual address to first physical address is not present in the second address translation data structure.

20. The data processing system of claim 17 wherein the instructions that cause the processing unit to transmit the intermediate address via the communications network comprise instructions that, when executed by the processing unit, cause the processing unit to identify one of the hardware sets of the data processing system responsible for maintaining status information for the first data object.

21. The data processing system of claim 20 wherein the instructions that cause the processing unit to identify the one of the hardware sets responsible for maintaining status information for the first data object comprise instructions which, when executed by the processing unit, cause the processing unit to identify the one of the hardware sets based on a field of bits within the intermediate address.

22. The data processing system of claim 21 wherein the instructions that cause the processing unit to identify the one of the hardware sets based on a field of bits within the intermediate address comprise instructions which, when executed by the processing unit, cause the processing unit to index a lookup data structure using the field of bits.

23. The data processing system of claim 21 wherein the instructions that cause the processing unit to identify the one of the hardware sets based on a field of bits within the intermediate address comprise instructions which, when executed by the processing unit, cause the processing unit to identify the one of the hardware sets directly from the field of bits.

24. The data processing system of claim 17 wherein the first data object is a memory page that spans a plurality of individually accessible storage locations within the memory of at least one of the plurality of hardware sets.

25. A computer-readable medium carrying one or more sequences of instructions which, when executed by a processing unit, cause the processing unit to:
detect an instruction that indicates a memory reference at a first virtual address;
index a first address translation data structure to obtain an intermediate address that corresponds to the first virtual address;
transmit the intermediate address via a communications network in a request for a copy of a first data object that corresponds to the intermediate address;
receive a copy of the first data object that corresponds to the intermediate address via the communications network;
store the copy of the first data object in memory at a first physical address; and
load a second address translation data structure with translation information that indicates a translation of the first virtual address to the first physical address.

26. The computer-readable medium of claim 25 wherein the instructions further cause the processing unit to index the second address translation data structure using the first virtual address to obtain the first physical address indicated by the translation information.

27. The computer-readable medium of claim 25 wherein the instructions further cause the processing unit to:
index the second address translation data structure using the first virtual address; and
determine whether a translation from the first virtual address to the first physical address is present in the second address translation data structure, and wherein instructions that cause the processing unit to index the first address translation data structure to obtain the intermediate address are not executed if the translation from the first virtual address to first physical address is present in the second address translation data structure.

28. The computer-readable medium of claim 25 wherein the instructions that cause the processing unit to transmit the intermediate address via the communications network comprise instructions that, when executed by the processing unit, cause the processing unit to identify a data processing entity responsible for maintaining status information for the first data object.

29. The computer-readable medium of claim 28 wherein the instructions that cause the processing unit to identify the data processing entity responsible for maintaining status information for the first data object comprise instructions which, when executed by the processing unit, cause the processing unit to identify the data processing entity based on a field of bits within the intermediate address.

30. The computer-readable medium of claim 29 wherein the instructions that cause the processing unit to identify the data processing entity based on a field of bits within the intermediate address comprise instructions which, when executed by the processing unit, cause the processing unit to index a lookup data structure using the field of bits.

31. The computer-readable medium of claim 29 wherein the instructions that cause the processing unit to identify the data processing entity based on a field of bits within the intermediate address comprise instructions which, when executed by the processing unit, cause the processing unit to identify the one of the hardware sets directly from the field of bits.

32. The computer-readable medium of claim 25 wherein the first data object is a memory page that spans a plurality of individually accessible storage locations within a memory device.
